(19) United States
(12) Patent Application Publication
(10) Pub. No.: US 2022/0194318 A1
(43) Pub. Date: Jun. 23, 2022

(54) VEHICLE MONITORING METHOD AND VEHICLE MONITORING DEVICE

(71) Applicant: Panasonic Intellectual Property Management Co., Ltd., Osaka (JP)

(72) Inventors: Masakiyo NISHIKAWA, Nara (JP); Takashi KOMATSU, Osaka (JP); Mikihito TAKEHARA, Osaka (JP)

(73) Assignee: Panasonic Intellectual Property Management Co., Ltd., Osaka (JP)

(21) Appl. No.: 17/546,700

(22) Filed: Dec. 9, 2021

(30) Foreign Application Priority Data
Dec. 21, 2020 (JP) 2020-211862

(51) Int. Cl. B60R 25/31; B60R 25/24; B60R 25/01; B60R 22/48; B60R 25/02; B60R 25/00; B60R 25/104; B60H 1/00; B60K 31/00; B60R 25/32; B60R 25/34; E05B 81/56; E05F 15/73

(52) U.S. Cl. CPC B60R 25/31; E05Y 2900/55; B60R 25/016; B60R 22/48; B60R 25/02; B60R 25/005; B60R 25/007; B60R 25/104; B60H 1/00657; B60K 31/00; B60R 25/32; B60R 25/34; E05B 81/56; E05F 15/73; B60R 2022/4816; B60R 2022/4866; E05Y 2400/44; E05Y 2400/45; B60R 25/24

(57) ABSTRACT

A monitor monitors whether a person is present inside a vehicle that travels in an automated driving mode. The monitor also monitors the state of the vehicle. A controller performs one or more actions according to the result of monitoring of the monitor. This means that when one or more persons are present inside the vehicle, the controller performs one or more actions according to the state of the vehicle. In other words, when no person is present inside the vehicle, the controller does not perform one or more actions. Here, the controller generates control information for controlling the vehicle according to the result of the monitoring, and transmits it to the vehicle.

### CROSS REFERENCE TO RELATED APPLICATION

The present application is based on and claims priority of Japanese Patent Application No. 2020-211862 filed on Dec. 21, 2020.

### FIELD

The present disclosure relates to vehicle monitoring methods and vehicle monitoring devices.

### BACKGROUND

PTL 1 discloses a method for inspecting whether one or more persons are present inside a vehicle which is present in a parking lot and is in an autonomous operation mode and monitoring the vehicle on which one or more actions are performed depending on the inspection.

### CITATION LIST

### Patent Literature

PTL 1: Japanese Unexamined Patent Application Publication (Translation of PCT Application) No. 2018-505488

### SUMMARY

However, the guidance method according to PTL 1 can be improved upon.

In view of this, the present disclosure provides a vehicle monitoring method and a vehicle monitoring device capable of improving upon the above related art.

A vehicle monitoring method according to one aspect of the present disclosure is a vehicle monitoring method for monitoring a vehicle that is present in a parking lot and is in an automated driving mode, and the vehicle monitoring method includes: monitoring a state of the vehicle and whether a person is present inside the vehicle; and performing one or more actions based on a result of the monitoring.

A vehicle monitoring device according to one aspect of the present disclosure is a vehicle monitoring device for monitoring a vehicle that is present in a parking lot and is in an automated driving mode, and the vehicle monitoring device includes: a monitor that monitors a state of the vehicle and whether a person is present inside the vehicle; and a controller that performs one or more actions based on a result of the monitoring of the monitor.

These comprehensive or specific aspects may be realized by a system, a method, an integrated circuit, a computer program, or a computer-readable recording medium such as a CD-ROM, or may be realized by any combination of the system, the method, the integrated circuit, the computer program, and the recording medium.

A vehicle monitoring method according to one aspect of the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a block diagram showing an example of the configuration of a parking lot management system in an embodiment.

FIG. 2 is a block diagram showing an example of the configuration of a vehicle monitoring device according to the embodiment.

FIG. 3 is a flowchart showing the operation of the vehicle monitoring device according to the embodiment.

### DESCRIPTION OF EMBODIMENTS

In an automated (autonomous) parking lot, which is the so-called valet parking, when a driver passes a vehicle at a delivery place, the vehicle autonomously travels from the delivery place to a parking position in an automated driving mode. Then, the vehicle autonomously returns again to a reception position in the automated driving mode. However, in the vehicle that travels in the automated driving mode, one or more persons may be left. It is likely that depending on acts of these persons, an accident occurs within the parking lot to prevent the operation of the parking lot.

As described above, in PTL 1, whether one or more persons are present inside the vehicle being parked in the parking lot in the autonomous operation mode is inspected, and when one or more persons are present therewithin, one or more actions are performed. When one or more persons are present in the vehicle, one or more actions are performed to be able to reduce the risk of a collision between these persons and, for example, another vehicle in the parking lot.

However, for example, while one or more actions are being performed, the person inside the vehicle may perform an act of endangering safety such as an act of driving the vehicle or an act of getting out of the vehicle to make a movement. When the person performs such an act, an accident may occur either on the person or between the person and the vehicle. Even when the person does not perform the act described above, for example, depending on an environment inside the vehicle (for example, where the temperature inside the vehicle is high), an influence may be exerted on the life of the person. In other words, smooth operation of the parking lot may be prevented.

Hence, the present disclosure provides a vehicle monitoring method and a vehicle monitoring device that can smoothly operate a parking lot when a person is present inside a vehicle that is present in the parking lot in an automated driving mode.

A vehicle monitoring method according to one aspect of the present disclosure is a vehicle monitoring method for monitoring a vehicle that is present in a parking lot and is in an automated driving mode, and the vehicle monitoring method includes: monitoring a state of the vehicle and whether a person is present inside the vehicle; and performing one or more actions based on a result of the monitoring.

In this way, when one or more persons are present inside the vehicle, it is possible to take optimal measures corresponding to the state of the vehicle. Hence, it is possible to prevent the person inside the vehicle from inhibiting traffic flow within the parking lot or traffic therewithin. It is also possible to reduce the risk of occurrence of an accident either on the person or between the person and another vehicle. It is also possible to guarantee the safety of the person inside the vehicle. In other words, it is possible to smoothly operate the parking lot.

A vehicle monitoring device according to one aspect of the present disclosure is a vehicle monitoring device for monitoring a vehicle that is present in a parking lot and is in an automated driving mode, and the vehicle monitoring device includes: a monitor that monitors a state of the vehicle and whether a person is present inside the vehicle; and a controller that performs one or more actions based on a result of the monitoring of the monitor.

In the vehicle monitoring device described above, the same operation effects described above are achieved.

For example, the state of the vehicle includes whether a door of the vehicle is in a locked state, and the one or more actions include transmission of control information for setting the door to the locked state to the vehicle via a communication network. In this way, it is likely that the getting out of the vehicle by the person can be suppressed. Hence, it is likely that an accident within the parking lot can be reduced.

For example, the state of the vehicle includes whether a door of the vehicle is in a locked state, and the one or more actions include transmission of control information for releasing the locked state of the door to the vehicle via a communication network. In this way, it is likely that when the person repeats an unlocking operation in a state where the vehicle is stopped, the operation of the person can be prioritized. Hence, it is likely that anxiety in which the person is prevented from getting out of the vehicle can be eliminated. For example, when the person is in danger inside the vehicle (for example, a fire in the vehicle), it is possible to prioritize the intention of the person.

For example, the state of the vehicle includes an open state or a closed state of a window of the vehicle, and the one or more actions include transmission of control information for setting the window to a closed state to the vehicle via a communication network. In this way, it is likely that the performance of a dangerous action of, for example, putting part of the body of the person such as the head or a hand out of the window, leaning out of the window, or escaping through the window can be suppressed. Hence, it is likely that an accident within the parking lot can be reduced.

For example, the state of the vehicle includes a fastening state of a seatbelt provided in a seat of the vehicle, and the one or more actions include transmission of control information for instructing the person inside the vehicle to fasten the seatbelt to the vehicle via a communication network. In this way, it is likely that the person can be alerted to fasten the seatbelt. Hence, it is likely that the safety of the person can be ensured.

For example, the state of the vehicle includes a fastening state of a seatbelt provided in a seat of the vehicle, and the one or more actions include transmission of control information for setting the seatbelt to a locked state to the vehicle via a communication network. In this way, it is likely that the removal of the seatbelt by the person can be suppressed. Hence, it is likely that the safety of the person can be ensured.

For example, the state of the vehicle includes an of a steering wheel, and the one or more actions include transmission of control information for setting the steering wheel to a non-operating state to the vehicle via a communication network. In this way, it is likely that the operation of the steering wheel by the person can be prevented. Hence, it is likely that prevention of travel of the vehicle in an automated driving mode is avoided. Therefore, it is likely that smooth operation of the parking lot can be performed.

For example, the state of the vehicle includes an operating state of a pedal, and the one or more actions include transmission of control information for setting the pedal to a non-operating state to the vehicle via a communication network. In this way, it is likely that the operation of the pedal by the person can be prevented. Hence, since the travel of the vehicle in the automated driving mode is not prevented, it is likely that smooth operation of the parking lot can be performed to enhance the safety.

For example, the state of the vehicle includes an operating state of a lever switch of the vehicle, and the one or more actions include transmission of control information for setting the lever switch of the vehicle to a non-operating state to the vehicle via a communication network. In this way, it is likely that the operation of the lever switch by the person can be prevented. Hence, it is likely that prevention of travel of the vehicle in the automated driving mode is avoided. Therefore, it is likely that smooth operation of the parking lot can be performed.

For example, the one or more actions include transmission of control information for causing a sound generator incorporated in the vehicle to output a sound to the vehicle via a communication network. In this way, it is likely that, for example, the person can be alerted by the sound or can be notified of the current situation or the like. Hence, it is likely that the person can avoid performing an act of endangering safety and can grasp the circumstances to have a feeling of security.

For example, the one or more actions include transmission of control information for causing a display device incorporated in the vehicle to display an image to the vehicle via a communication network. In this way, it is likely that, for example, the person can be visually alerted or can be notified of the current situation or the like. Hence, it is likely that the person can avoid performing an act of endangering safety and can grasp the circumstances to have a feeling of security.

For example, the state of the vehicle includes an operating state of an illumination device incorporated in the vehicle, and the one or more actions include transmission of control information for operating the illumination device to the vehicle via a communication network. In this way, it is likely that the interior of the vehicle can be brought into an appropriate illuminated state. Hence, it is likely that a feeling of anxiety in the person can be reduced, for example, at nighttime.

For example, the state of the vehicle includes an operating state of an air conditioner that conditions air inside the vehicle, and the one or more actions include transmission of control information for operating the air conditioner to the vehicle via a communication network. In this way, it is likely that the interior of the vehicle can be brought into an appropriate air-conditioned state. Hence, it is likely that creation of an unhealthy environment (such as a high-temperature state) inside the vehicle can be avoided.

For example, the state of the vehicle includes a temperature inside the vehicle, and the one or more actions include transmission of control information for operating the air conditioner according to the temperature to the vehicle via the communication network. In this way, it is likely that the interior of the vehicle can be adjusted according to the temperature inside the vehicle to have an appropriate temperature. Hence, it is likely that creation of an unhealthy environment (such as a high-temperature state) inside the vehicle can be avoided.

For example, the one or more actions include transmission of control information for stopping the vehicle to the vehicle via a communication network. For example, the one or more actions include transmission of control information for causing the vehicle to autonomously travel to an avoidance position to the vehicle via a communication network. For example, the state of the vehicle includes a vehicle speed of the vehicle, and the one or more actions include transmission of control information for controlling a speed of the vehicle according to the vehicle speed to the vehicle via a communication network.

In this way, it is likely that the affecting of travel of another vehicle in the parking lot can be reduced. Hence, it is likely that smooth operation of the parking lot can be performed.

For example, the control information includes a control priority that indicates priority of control in the vehicle. In this way, it is possible to perform control on the vehicle in descending order of priority. Hence, it is likely that smooth operation of the parking lot can be performed.

### Embodiment

A vehicle monitoring device according to an embodiment will be described below with reference to drawings.

### [1. Configuration]

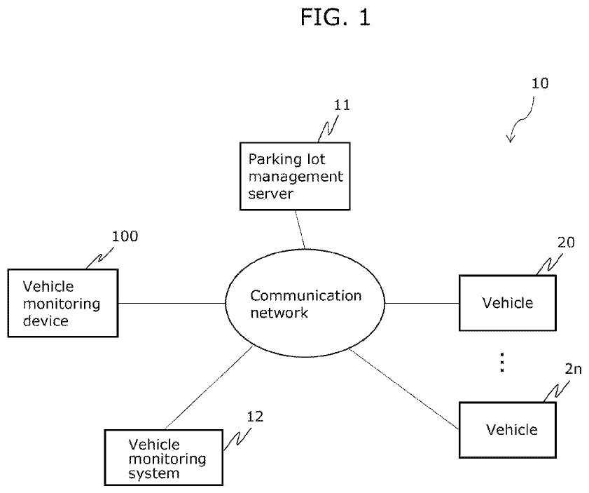

FIG. 1 is a block diagram showing an example of the configuration of a parking lot management system in the embodiment. Parking lot management system 10 includes at least vehicle monitoring device 100 and parking lot management server 11. Parking lot management system 10 may include vehicle monitoring system 12 that monitors a vehicle. Parking lot management server 11, vehicle monitoring device 100, and vehicle monitoring system 12 communicate with each other via a communication network. The communication network may include a mobile communication network (radio access network). The communication network may also include a wireless LAN (WLAN).

Parking lot management server 11 manages a parking lot that includes a plurality of parking spaces, the parking positions of one or more vehicles 20 to 2n (n is an integer greater than or equal to 1) that are passed to the parking lot, the operation of the vehicles within the parking lot, and the like. Vehicle monitoring device 100 monitors vehicles 20 to 2n and the states of the interiors of vehicles 20 to 2n.

Vehicles 20 to 2n are vehicles that can autonomously travel in an automated driving mode. Vehicles 20 to 2n have a communication function and are connected to parking lot management server 11 and vehicle monitoring device 100 via the communication network. The automated driving mode means that the vehicle autonomously travels or travels by remote control. In the automated driving mode, the vehicle does not require a driving operation performed by a person. In other words, the driver does not need to be present inside the vehicle in the automated driving mode.

The present disclosure is targeted for a vehicle in the automated driving mode in a parking lot. Hence, the present disclosure is not targeted for a vehicle which is not in the automated driving mode, that is, is not targeted for a vehicle in a manual driving mode. This is because in the vehicle in the manual driving mode, a person needs to be present inside the vehicle in order to cause the vehicle to travel. The present disclosure is performed in an automated parking process or only at a time when the mode of the vehicle is switched to the automated driving mode. Here, the automated parking process includes autonomous travel from a delivery position to a parking position. The automated parking process also includes an autonomous operation of entering the parking position and an autonomous operation of exiting from the parking position. The automated parking process also includes autonomous travel from the parking position to a reception position.

The delivery position is a position in which the driver of the vehicle switches to the automated driving mode in the vehicle and in which the driver can stop the vehicle to get out of the vehicle. The delivery position is located, for example, around the entrance of the parking lot. The reception position is a position in which the driver of the vehicle can receive the vehicle after the automated parking process. The reception position is located, for example, around the exit of the parking lot. The delivery position and the reception position may be the same as each other or different from each other.

The parking lot is a region where vehicles are parked, and is an area that includes a plurality of parking spaces or parking sections. The parking lot may have a three-dimensional structure like a parking building. The parking lot may be an outdoor type or an indoor type.

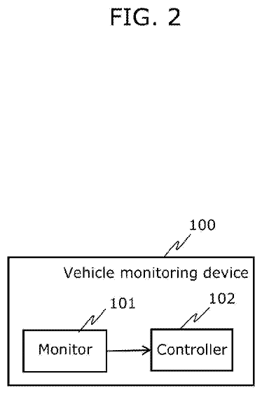

FIG. 2 is a block diagram showing the configuration of vehicle monitoring device 100 according to the embodiment. As shown in FIG. 2, vehicle monitoring device 100 includes monitor 101 and controller 102. Monitor 101 and controller 102 indicate not substantial configurations but functions realized by vehicle monitoring device 100. More specifically, a processor (such as a central processing unit (CPU)) (not shown) included in vehicle monitoring device 100 executes predetermined programs with a memory (not shown) to be able to realize monitor 101 and controller 102.

A description will be given below using, as an example, a case where a target vehicle to be monitored is vehicle 20. In vehicle monitoring device 100, a plurality of vehicles may be targets to be monitored at the same time.

Monitor 101 monitors the state of presence of the person within vehicle 20 that is present in the parking lot in the automated driving mode. In other words, monitor 101 monitors whether one or more persons are present within vehicle 20. Monitor 101 also monitors the state of vehicle 20. The state of presence of the person within vehicle 20 may be acquired from vehicle monitoring system 12 outside the vehicle. For example, vehicle monitoring device 100 may include vehicle monitoring system 12. In the following description, when the “person” is mentioned, it indicates one or more persons.

Vehicle monitoring system 12 may have a configuration in which a plurality of camera are arranged within the parking lot and in which vehicle 20 and the state of the interior of vehicle 20 are monitored by video captured with the cameras. Vehicle monitoring system 12 uses the captured video to determine whether one or more persons are present within vehicle 20. Vehicle monitoring system 12 may use the captured video to monitor the state of travel of vehicle 20, the travel speed thereof, or the like.

The state of presence of the person within vehicle 20 may be acquired from a vehicle sensor system (not shown) for detecting, by sensing, the state of presence with various types of sensors installed in the vehicle. An example of the sensor is a seating sensor. The seating sensor detects whether a seat is occupied. The vehicle sensor system may perform sensing by video captured with cameras included in the vehicle. An example of the camera is an image sensor such as a complementary metal oxide semiconductor (CMOS) image sensor or a charge coupled device (CCD) image sensor.

Vehicle monitoring device 100 communicates with vehicle monitoring system 12 or the vehicle sensor system via the communication network. In the vehicle sensor system, the startup, the operation, or the like of the sensing may be controlled from outside the vehicle or the result of the sensing may be spontaneously transmitted to the vehicle sensor system.

Monitor 101 acquires the state of vehicle 20 from the vehicle sensor system. Examples of the state of the vehicle includes the locked state of a door, the open state or the closed state of a window, the fastening state of a seatbelt provided in the seat, the operating state of a steering wheel, the operating state of a pedal, the operating state of a lever switch, the operating state of an illumination device, an illuminance inside the vehicle, the operating state of an air conditioner, and a temperature inside the vehicle.

The vehicle sensor system includes, for example, a door sensor, a seatbelt sensor, a steering angle sensor, a pedal sensor, a shift sensor, a temperature sensor, an illuminance sensor, or a vehicle speed sensor. The door sensor detects the open state or the closed state of the door. The rudder angle sensor detects the steering angle of the steering wheel. The pedal sensor detects the amount of stepping of an accelerator pedal. The shift sensor detects the state of the switch of the lever switch operated by the driver and an operation position (shift position). The temperature sensor detects the temperature within vehicle 20. The illuminance sensor detects illuminances inside and outside vehicle 20. The vehicle speed sensor detects the speed of vehicle 20.

Controller 102 performs one or more actions based on the result of monitoring of monitor 101. When one or more persons are present inside the vehicle, controller 102 performs one or more actions according to the state of the vehicle. The one or more actions include the transmission of control information produced by controller 102 on the vehicle via the communication network to the vehicle.

### [2. Operation]

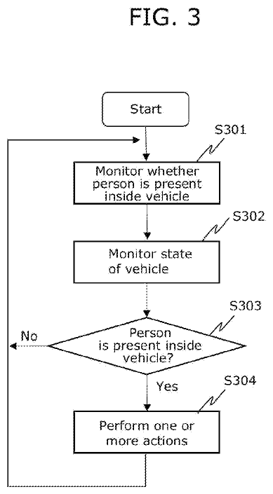

FIG. 3 is a flowchart showing the operation of vehicle monitoring device 100 according to the embodiment.

Monitor 101 monitors whether the person is present within vehicle 20 that travels in the automated driving mode (step S301). Monitor 101 also monitors the state of vehicle 20 (step S302). Controller 102 performs one or more actions according to the result of monitoring of monitor 101. This means that when one or more persons are present within vehicle 20, controller 102 performs one or more actions according to the state of vehicle 20. In other words, when no person is present within vehicle 20, controller 102 does not perform one or more actions. In the present embodiment, the control information for controlling vehicle 20 is generated according to the result of monitoring of controller 102, and is transmitted to the vehicle (steps S303 and S304).

These types of processing may be completed when it is determined in the processing of step S301 that no person is present inside the vehicle. These types of processing may be performed until vehicle 20 returns to the reception position.

In the flowchart of FIG. 3, the order of steps S302 and S303 may be reversed. In this case, when it is determined that no person is present inside the vehicle, the state of vehicle 20 is not monitored.

### [3. Operation Examples]

A description will be given below of the control information that is transmitted to the vehicle, and the transmission is included in one or more actions. Controller 102 may transmit, as the control information, a command that is executed by vehicle 20. Controller 102 may produce and transmit the control information. The control information is transmitted to vehicle 20 via the communication network.

### (Control of Door)

Monitor 101 monitors the state of presence of the person within vehicle 20 and the locked state of the door of vehicle 20, and outputs the result of the monitoring to controller 102. When controller 102 determines that one or more persons are present within vehicle 20, controller 102 may transmit, according to the locked state of the door of vehicle 20, the control information for controlling the locked state of the door to the vehicle.

When the door is not in the locked state, controller 102 may transmit, to vehicle 20, the control information for setting the door to the locked state. Controller 102 may transmit the control information for setting the door to the locked state until vehicle 20 is guided and stopped to and in such a position that the person can safely get out of vehicle 20. When the door is in the locked state, controller 102 may transmit, to vehicle 20, the control information for releasing the locked state of the door. Even when the door is set to the locked state, if the person repeats an operation of unlocking the door, vehicle monitoring system 12 may stop the transmission of the control information for setting the door to the locked state. When the control information for setting the door to the locked state is transmitted, controller 102 may transmit, to a sound generator or a display device incorporated in the vehicle, the control information which indicates that the door is in the locked state for safety and which is notified to the person within vehicle 20.

### (Control of Window)

Monitor 101 monitors the state of presence of the person within vehicle 20 and the open state or the closed state of the window of the vehicle, and outputs the result of the monitoring to controller 102. When controller 102 determines that one or more persons are present within vehicle 20, controller 102 may transmit, according to the open state or the closed state of the window of vehicle 20, the control information for controlling the open state or the closed state of the window to the vehicle.

When the window is in the open state, controller 102 may transmit, to vehicle 20, the control information for setting the window to the closed state. Controller 102 may transmit the control information for setting the window to the closed state until vehicle 20 is guided and stopped to and in such a position that the person can safely get out of vehicle 20. When the window is in the closed state, controller 102 may transmit, as necessary, the control information for setting the window to the open state to the vehicle. Even when the window is set to the closed state, if the person repeats an operation of unlocking the window, controller 102 may stop the transmission of the control information for setting the window to the closed state. When the control information for setting the window to the closed state is transmitted, controller 102 may transmit, to the sound generator or the display device incorporated in vehicle 20, the control information which indicates that the window is in the closed state for safety and which is notified to the person within vehicle 20. (Control of seatbelt)

Monitor 101 monitors the state of presence of the person within vehicle 20 and the fastening state of the seatbelt, and outputs the result of the monitoring to controller 102. When controller 102 determines that one or more persons are present within vehicle 20, controller 102 may transmit, according to the fastening state of the seatbelt, the control information for controlling the fastening state of the seatbelt to vehicle 20.

When the seatbelt is not in the fastening state, controller 102 may transmit, to the sound generator or the display device incorporated in the vehicle, the control information for instructing the person within vehicle 20 to fasten the seatbelt. When the seatbelt is not in the locked state, controller 102 may transmit, to vehicle 20, the control information for setting the seatbelt to the locked state. When the seatbelt is in the locked state, controller 102 may transmit, to vehicle 20, the control information for releasing the locked state of the seatbelt.

### (Control of Steering Wheel)

Monitor 101 monitors the state of presence of the person within vehicle 20 and the operating state of the steering wheel, and outputs the result of the monitoring to controller 102. When controller 102 determines that one or more persons are present within vehicle 20, controller 102 may transmit, according to the operating state of the steering wheel, the control information for controlling the operating state of the steering wheel to vehicle 20.

When the steering wheel is in the operating state, controller 102 may transmit, to vehicle 20, the control information which does not allow the operation of the steering wheel. Controller 102 may also transmit, to the sound generator or the display device incorporated in vehicle 20, the control information for instructing the person within vehicle 20 not to operate the steering wheel. In order to instruct the person within vehicle 20 not to operate the steering wheel, controller 102 may transmit the control information for vibrating the steering wheel.

### (Control of Pedal)

Monitor 101 monitors the state of presence of the person within vehicle 20 and the operating state of the pedal, and outputs the result of the monitoring to controller 102. When controller 102 determines that one or more persons are present within vehicle 20, controller 102 may transmit, according to the operating state of the pedal, the control information for controlling the operating state of the pedal to vehicle 20.

When the pedal is in the operating state, controller 102 may transmit, to vehicle 20, the control information for setting the pedal to a non-operating state. Controller 102 may also transmit, to the sound generator or the display device incorporated in vehicle 20, the control information for instructing the person within vehicle 20 not to operate the pedal. In order to instruct the person within vehicle 20 not to operate the pedal, controller 102 may transmit the control information for vibrating the pedal.

### (Control of Lever Switch)

Monitor 101 monitors the state of presence of the person inside the vehicle and the operating state of the lever switch, and outputs the result of the monitoring to controller 102. When controller 102 determines that one or more persons are present inside the vehicle, controller 102 may transmit, according to the operating state of the lever switch, the control information for controlling the operating state of the lever switch to vehicle 20.

When the lever switch is in the operating state, controller 102 may transmit, to vehicle 20, the control information for setting the lever switch to a non-operating state. Controller 102 may also transmit, to the sound generator or the display device incorporated in vehicle 20, the control information for instructing the person within vehicle 20 not to operate the lever switch.

### (Sound Generator)

When controller 102 determines that one or more persons are present within vehicle 20, controller 102 may transmit, to vehicle 20, the control information for causing the sound generator to output information that is notified to the person. Controller 102 may transmit, to vehicle 20, the control information for causing the sound generator to output a buzzer sound or an alert sound for alerting the person within vehicle 20 not to operate the vehicle. Controller 102 may also transmit, to vehicle 20, the control information for causing the sound generator to output a sound or the like which instructs the person not to operate vehicle 20, which instructs the person not to get out of the vehicle, or which describes the current situation or the like. The sound generator includes, for example, a speaker.

Controller 102 may cause the vehicle to receive sound information through a radio system, a television system, or the like. Controller 102 may transmit the control information for controlling the channel selection of a radio, a television, or the like incorporated in vehicle 20.

### (Image Display Device)

When controller 102 determines that one or more persons are present within vehicle 20, controller 102 may transmit, to vehicle 20, the control information for causing an image display device to display information that is notified to the person. The image display device is a display device such as a navigation device or a heads-up display that can display various types of information to the person. The display device may be a mobile terminal such as a smart phone. Controller 102 may transmit, to vehicle 20, the notified information using symbols, colors, images, text, or the like on the image display device.

### (Illumination Device)

Monitor 101 may monitor the state of presence of the person within vehicle 20 and the operating state of the illumination device, and output the result of the monitoring to controller 102. The illumination device includes a light source such as a light emitting diode (LED), and is installed on the ceiling of vehicle 20, an instrument panel, the pad of the steering wheel, or the like.

When controller 102 determines that one or more persons are present within vehicle 20, controller 102 may transmit, according to the illuminated state of the illumination device, the control information for controlling the operation of the illumination device to vehicle 20. When the illumination device is in an off state, controller 102 may transmit, to vehicle 20, the control information for setting the illumination device to an on state. In a specific time zone such as nighttime or in specific weather (for example, cloudy weather or rainy weather), controller 102 may transmit, to vehicle 20, the control information for setting the illumination device to the on state.

Monitor 101 may monitor the illuminance within vehicle 20 and output the result of the monitoring to controller 102. Controller 102 may transmit, according to the illuminance within vehicle 20, the control information for controlling the operation of the illumination device to vehicle 20.

### (Control of Air Conditioner)

Monitor 101 monitors the state of presence of the person within vehicle 20 and the operating state of the air conditioner, and outputs the result of the monitoring to controller 102. When controller 102 determines that one or more persons are present within vehicle 20, controller 102 may transmit, according to the operating state of the air conditioner, the control information for controlling the operation of the air conditioner to vehicle 20.

When the air conditioner is in an off state, controller 102 may transmit, to vehicle 20, the control information for setting the air conditioner to an on state. Controller 102 may transmit, according to weather or a date and time, the control information for setting the air conditioner to the on state. Controller 102 may determine, according to weather or a date and time, a temperature to which the air conditioner is set.

Monitor 101 may monitor the temperature within vehicle 20 and output the result of the monitoring to controller 102. Controller 102 may transmit, according to the temperature within vehicle 20, the control information for controlling the operation of the air conditioner to the vehicle. Controller 102 may determine the temperature according to the number of persons who are present inside the vehicle.

### (Travel Control)

When controller 102 determines that one or more persons are present within vehicle 20, controller 102 may transmit, to the vehicle, the control information for stopping vehicle 20. Controller 102 may transmit the control information for causing vehicle 20 to autonomously travel to an avoidance position. Controller 102 may also transmit the control information for controlling the speed of the vehicle at low speed. When controller 102 determines that the state of the vehicle affects safety, the travel control described above may be performed. Examples of the case described above include a case where the door of the vehicle is opened, a case where the person performs a driving operation, and the like.

### (Priority)

Controller 102 may include, in the control information, priority information indicating the priority of control in the vehicle. Controller 102 may transmit the control information which is transmitted when safety may be endangered more preferentially than the other control information. The vehicle performs the control information in descending order of priority. A higher priority may be assigned to the control information for higher safety.

### [4. Effects and the Like]

As described above, in the present embodiment, controller 101 monitors whether the person is present inside the vehicle that is present in the parking lot in the automated driving mode and the state of vehicle 20. Controller 102 performs one or more actions based on the result of monitoring of the monitor.

In this way, when one or more persons are present within vehicle 20, it is likely that it is possible to take optimal measures corresponding to the state of vehicle 20. Hence, it is likely that it is possible to smoothly operate the parking lot.

In the present embodiment, the state of the vehicle includes whether the door of vehicle 20 is in the locked state, and the one or more actions include the transmission of information for controlling the locked state of the door to vehicle 20. Monitor 101 monitors the locked state of the door of vehicle 20, and controller 102 transmits, to the vehicle, the control information for setting the door to the locked state. Monitor 101 may transmit the control information for setting the door to the locked state until vehicle 20 is guided and stopped to and in such a position that the person can safely get out of vehicle 20. In this way, it is likely that the getting out of vehicle 20 in a hurry by the person present in vehicle 20 can be suppressed.

Controller 102 transmits, to vehicle 20, the control information for releasing the locked state of the door. For example, when the person inside the vehicle performs an unlocking operation a predetermined number of times in a state where the vehicle is stopped, the operation of the person is prioritized, and thus it is likely that the anxiety of the person can be eliminated. For example, when the person is in danger inside the vehicle (for example, a fire in the vehicle), it is possible to prioritize the intention of the person.

The state of the vehicle includes the open state or the closed state of the window, and the one or more actions include the transmission of the control information for controlling the open state or the closed state of the window to vehicle 20. Monitor 101 monitors the open state or the closed state of the window of vehicle 20, and transmits, to vehicle 20, the control information for setting the window to the closed state. Monitor 101 may transmit, to vehicle 20, the control information for setting the window to the closed state until vehicle 20 is guided and stopped to and in such a position that the person can safely get out of vehicle 20. In this way, it is likely that the performance of a dangerous action of, for example, putting part of the body of the person within vehicle 20 such as the head or a hand out of the window, leaning out of the window, or escaping through the window can be suppressed. Hence, it is likely that an accident within the parking lot can be reduced.

Controller 102 transmits, to vehicle 20, the control information for setting the window to the open state. In this way, it is likely that when the person repeats an operation of opening the window, the operation of the person can be prioritized. Hence, it is likely that a sense of obstruction felt by the person can be reduced. For example, when the person is in danger inside the vehicle (for example, a fire in the vehicle), it is possible to prioritize the intention of the person.

The state of the vehicle includes the fastening state of the seatbelt provided in the seat of vehicle 20, and the one or more actions include any one of alerting the person to fasten the seatbelt, setting the seatbelt to the locked state, and releasing the locked state. Monitor 101 monitors the fastening state of the seatbelt provided in the seat of vehicle 20, and controller 102 transmits the control information for instructing the person within vehicle 20 to fasten the seatbelt. In this way, it is likely that it is possible to alert the person inside the vehicle to fasten the seatbelt and that thus it is possible to enhance the safety of the person. Hence, it is likely that it is possible to ensure the safety of the person.

Controller 102 transmits the control information for setting the seatbelt to the locked state. In this way, for example, when the person is a child, it is likely that the performance of a dangerous action can be suppressed. Controller 102 transmits the control information for releasing the locked state of the seatbelt. In this way, when the person repeats an operation of releasing the locked state of the seatbelt, it is possible to release the locked state. Hence, it is likely that a feeling of anxiety in the person can be reduced. For example, when the person is in danger inside the vehicle (for example, a fire in the vehicle), it is possible to prioritize the intention of the person.

The state of the vehicle includes the operating state of the steering wheel, and the one or more actions include the transmission of the control information for setting the steering wheel to a non-operating state. Monitor 101 monitors the operating state of the steering wheel, and controller 102 transmits, according to the result of the monitoring, the control information for setting the steering wheel to the non-operating state. In this way, since prevention of travel of vehicle 20 in the automated driving mode is avoided, it is likely that it is possible to smoothly operate the parking lot to enhance the safety.

The state of the vehicle includes the operating state of the pedal, and controller 102 transmits, to the vehicle, the control information for setting the pedal to the non-operating state. In this way, since prevention of travel of vehicle 20 in the automated driving mode is avoided, it is likely that it is possible to smoothly operate the parking lot to enhance the safety.

The state of the vehicle includes the operating state of the lever switch, and the one or more actions include the transmission of the control information for setting the lever switch to the non-operating state to the vehicle via the communication network. Monitor 101 monitors the operating state of the lever switch, and controller 102 transmits, according to the result of the monitoring, the control information for the lever switch to vehicle 20. In this way, since prevention of travel of vehicle 20 in the automated driving mode is avoided, it is likely that it is possible to smoothly operate the parking lot to enhance the safety.

The one or more actions include the transmission of the control information for causing the sound generator incorporated in vehicle 20 to output a sound to vehicle 20 via the communication network. Controller 102 transmits, to vehicle 20, the control information for causing the sound generator to output the sound. In this way, for example, the person can be alerted by the sound or a description can be given of the current situation or the like, and thus it is likely that the person can avoid performing an act of endangering safety and can grasp the circumstances to have a feeling of security.

The one or more actions include the transmission of the control information for causing the display device incorporated in vehicle 20 to display an image to the vehicle via the communication network. Controller 102 transmits, to vehicle 20, the control information for causing the display device to display the image including symbols or graphics indicating an alert, a sentence for describing the circumstances or the like. In this way, for example, the person can be visually alerted or a description can be given of the current situation, and thus it is likely that the person can avoid performing an act of endangering safety and can grasp the circumstances to have a feeling of security.

The state of the vehicle includes the operating state of the illumination device incorporated in vehicle 20, and the one or more actions include the transmission of the control information for operating the illumination device to the vehicle via the communication network. The state of the vehicle includes the illuminance inside the vehicle, and the one or more actions include the transmission of the control information for operating the illumination device according to the illumination to vehicle 20 via the communication network. Monitor 101 monitors the state of the illumination device and the illuminance inside the vehicle, and controller 102 transmits the control information for the illumination device to vehicle 20. In this way, it is likely that the interior of vehicle 20 can be brought into an appropriate illuminated state, and that a feeling of anxiety in the person can be reduced.

The state of the vehicle includes the operating state of the air conditioner that conditions air inside the vehicle, and the one or more actions include the transmission of the control information for operating the air conditioner to the vehicle via the communication network. The state of the vehicle includes the temperature inside the vehicle, and the one or more actions include the transmission of the control information for operating the air conditioner according to the temperature to vehicle 20 via the communication network. Monitor 101 monitors the state of the air conditioner and the temperature inside the vehicle, and controller 102 transmits, to vehicle 20, the control information for the air conditioner. In this way, it is likely that the temperature within vehicle 20 can be appropriately maintained, and that thus a poor health condition such as dehydration in midsummer can be avoided.

The one or more actions include the transmission of the control information for stopping the vehicle via the communication network to the vehicle. The one or more actions include the transmission of the control information for causing vehicle 20 to autonomously travel to the avoidance position to vehicle 20 via the communication network. The state of vehicle 20 includes the vehicle speed, and the one or more actions include the transmission of the control information for controlling the vehicle speed to vehicle 20 via the communication network. In this way, it is likely that the affecting of travel of another vehicle in the parking lot by vehicle 20 can be reduced, and that thus it is possible to smoothly operate the parking lot.

The control information includes a control priority that indicates the priority of control in vehicle 20. Controller 102 gives the control priority to the control information. A higher priority is given to an action of a higher urgency, and thus it is likely that the safety of the person within vehicle 20 can be ensured and that thus the occurrence of an accident within the parking lot can be avoided. In other words, it is likely that it is possible to smoothly operate the parking lot.

### Other Embodiments

The embodiment has been described above as an example of techniques disclosed in the present application. However, the techniques in the present disclosure are not limited to this embodiment, and can also be applied to embodiments obtained by performing modification, replacement, addition, omission, and the like as necessary. Constituent elements described in the above embodiment and other embodiments below can be combined to form new embodiments.

Hence, the other embodiments will be illustrated below.

Although in the embodiment, the one or more actions are targeted for the vehicle or the person inside the vehicle, the present disclosure is not limited to this configuration. For example, a runaway stopping device such as wheel chocks installed in the parking space may be controlled. When the vehicle cannot make an emergency stop, the runaway stopping device is locked, and thus movement of the vehicle in a passage or the parking space within the parking lot can be suppressed, with the result that the it is possible to ensure the safety. When a traffic light is installed within the parking lot, the control information for controlling the traffic light may be transmitted. It is likely that the vehicle identifies the state of the traffic light to be able to perform an appropriate operation. When a crossing gate is set within the parking lot, the control information for controlling the crossing gate may be transmitted.

Although in the embodiment, one-way communication for communicating the control information from the vehicle monitoring device to the vehicle is only performed, two-way communication may be performed. For example, the person inside the vehicle may use a voice call or the like to perform two-way communication with a management center for the parking lot. It is likely that the person inside the vehicle has a conversation with the management center to be able to accurately grasp the circumstances. The person inside the vehicle may use an information terminal installed in the vehicle to acquire information for grasping the current situation. As described above, the person inside the vehicle can grasp the current position, the position in which the person gets out of the vehicle, the time until which the person can get out of the vehicle, the time at which the observer of the management center arrives and the like, and thus it is likely that a feeling of security is given and that an inappropriate act can be suppressed.

Although in the embodiment, one or more actions are performed when one or more persons are present inside the vehicle, a configuration may be adopted where this is not applied to a vehicle within which the person is allowed to be present. Examples thereof include a case where a service vehicle in the parking lot or a vehicle in which a failure or the like occurs is driven by an employee of the parking lot.

Although in the embodiment, the control information for controlling the illumination device according to the illuminance inside the vehicle or outside the vehicle is transmitted, the control information corresponding to a time zone may be transmitted. For example, the control information for turning on the illumination device only in a time zone during the nighttime may be transmitted. The control information for controlling the illumination device according to weather may be transmitted. For example, since the illuminance outside the vehicle is low in cloudy weather or rainy weather, the control information for turning on the illumination device may be transmitted.

Although the form of the vehicle monitoring device has been described above according to the embodiments, the form of the vehicle monitoring device is not limited to the embodiments. Variations that are conceived by a person skilled in the art may be performed on the embodiments, and a plurality of constituent elements in the embodiments may be arbitrarily combined together.

For example, processing that is performed with a specific constituent element in the embodiments may be performed with another constituent element instead of the specific constituent element. The order of a plurality of types of processing may be changed or a plurality of types of processing may be performed at the same time.

The vehicle monitoring method that includes steps performed with the constituent elements of the vehicle monitoring device may be performed with an arbitrary device or system. For example, part or all of the vehicle monitoring method may be executed with a computer (for example, an information processing circuit) that includes a processor, a memory, an input/output circuit, and the like. Here, programs for instructing the computer to execute the vehicle monitoring method may be executed by the computer to execute the vehicle monitoring method.

In a non-transitory computer-readable recording medium, the programs described above may be recorded.

The constituent elements of the vehicle monitoring device may be formed by dedicated hardware, may be formed by general-purpose hardware for executing the programs described above and the like or may be formed by combining them together. The general-purpose hardware may be formed with a memory in which programs are recorded, a general-purpose processor which reads a program from the memory to execute the program and the like. Here, the memory may be a semiconductor memory, a hard disk, or the like, and the general-purpose processor may be a CPU or the like.

The dedicated hardware may be formed with a memory, a dedicated processor, and the like. For example, the dedicated processor may reference a memory for recording data to execute the vehicle monitoring device described above.

The constituent elements of the vehicle monitoring device may be electrical circuits. These electrical circuits may form one electrical circuit as a whole or may be separate electrical circuits. These electrical circuits may correspond to dedicated hardware or may correspond to general-purpose hardware that executes the programs described above and the like.

While various embodiments have been described herein above, it is to be appreciated that various changes in form and detail may be made without departing from the spirit and scope of the present disclosure as presently or hereafter claimed.

Further Information about Technical Background to this Application

The disclosures of the following patent applications including specification, drawings and claims are incorporated herein by reference in their entirety: Japanese Patent Application No. 2020-211862 filed on Dec. 21, 2020.

### INDUSTRIAL APPLICABILITY

The present disclosure can be utilized for a vehicle monitoring method for monitoring a vehicle that performs a parking operation in an automated driving mode.

1. A vehicle monitoring method for monitoring a vehicle that is present in a parking lot and is in an automated driving mode, the vehicle monitoring method comprising:
monitoring a state of the vehicle and whether a person is present inside the vehicle; and
performing one or more actions based on a result of the monitoring.

2. The vehicle monitoring method according to claim 1,
wherein the state of the vehicle includes whether a door of the vehicle is in a locked state, and
the one or more actions include transmission of control information for setting the door to the locked state to the vehicle via a communication network.

3. The vehicle monitoring method according to claim 1,
wherein the state of the vehicle includes whether a door of the vehicle is in a locked state, and
the one or more actions include transmission of control information for releasing the locked state of the door to the vehicle via a communication network.

4. The vehicle monitoring method according to claim 1,
wherein the state of the vehicle includes an open state or a closed state of a window of the vehicle, and
the one or more actions include transmission of control information for setting the window to a closed state to the vehicle via a communication network.

5. The vehicle monitoring method according to claim 1,
wherein the state of the vehicle includes a fastening state of a seatbelt provided in a seat of the vehicle, and
the one or more actions include transmission of control information for instructing the person inside the vehicle to fasten the seatbelt to the vehicle via a communication network.

6. The vehicle monitoring method according to claim 1,
wherein the state of the vehicle includes a fastening state of a seatbelt provided in a seat of the vehicle, and
the one or more actions include transmission of control information for setting the seatbelt to a locked state to the vehicle via a communication network.

7. The vehicle monitoring method according to claim 1,
wherein the state of the vehicle includes an operating state of a steering wheel, and
the one or more actions include transmission of control information for setting the steering wheel to a non-operating state to the vehicle via a communication network.

8. The vehicle monitoring method according to claim 1,
wherein the state of the vehicle includes an operating state of a pedal, and
the one or more actions include transmission of control information for setting the pedal to a non-operating state to the vehicle via a communication network.

9. The vehicle monitoring method according to claim 1,
wherein the state of the vehicle includes an operating state of a lever switch of the vehicle, and
the one or more actions include transmission of control information for setting the lever switch of the vehicle to a non-operating state to the vehicle via a communication network.

10. The vehicle monitoring method according to claim 1,
wherein the one or more actions include transmission of control information for causing a sound generator incorporated in the vehicle to output a sound to the vehicle via a communication network.

11. The vehicle monitoring method according to claim 1,
wherein the one or more actions include transmission of control information for causing a display device incorporated in the vehicle to display an image to the vehicle via a communication network.

12. The vehicle monitoring method according to claim 1,
wherein the state of the vehicle includes an operating state of an illumination device incorporated in the vehicle, and
the one or more actions include transmission of control information for operating the illumination device to the vehicle via a communication network.

13. The vehicle monitoring method according to claim 1,
wherein the state of the vehicle includes an operating state of an air conditioner that conditions air inside the vehicle, and
the one or more actions include transmission of control information for operating the air conditioner to the vehicle via a communication network.

14. The vehicle monitoring method according to claim 13,
wherein the state of the vehicle includes a temperature inside the vehicle, and
the one or more actions include transmission of control information for operating the air conditioner according to the temperature to the vehicle via the communication network.

15. The vehicle monitoring method according to claim 1,
wherein the one or more actions include transmission of control information for stopping the vehicle to the vehicle via a communication network.

16. The vehicle monitoring method according to claim 1,
wherein the one or more actions include transmission of control information for causing the vehicle to autonomously travel to an avoidance position to the vehicle via a communication network.

17. The vehicle monitoring method according to claim 1,
wherein the state of the vehicle includes a vehicle speed of the vehicle, and
the one or more actions include transmission of control information for controlling a speed of the vehicle according to the vehicle speed to the vehicle via a communication network.

18. The vehicle monitoring method according to claim 17,
wherein the control information includes a control priority that indicates priority of control in the vehicle.

19. A vehicle monitoring device for monitoring a vehicle that is present in a parking lot and is in an automated driving mode, the vehicle monitoring device comprising:
a monitor that monitors a state of the vehicle and whether a person is present inside the vehicle; and
a controller that performs one or more actions based on a result of the monitoring of the monitor.
